(19) United States
(12) Patent Application Publication
(10) Pub. No.: US 2005/0052573 A1
(43) Pub. Date: Mar. 10, 2005

(54) Video display device

(76) Inventor: Richard Schiller, Twickenham (GB)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/798,778

(22) Filed: Mar. 12, 2004

(30) Foreign Application Priority Data
Mar. 12, 2003 (GB) 0305678.5

(51) Int. Cl. H04N 7/01

(52) U.S. Cl. 348/445; 348/588

(57) ABSTRACT

A method of displaying a video signal together with associated information. A video signal is transformed to a different scanning raster including an aspect ratio change, such that the transformed video occupies only part of the output scanning raster. The unused part of the raster is then used to display the associated information. The invention may be embodied in a downconverter for converting High Definition to Standard Definition video. The associated information may represent control room parameters, the display which can be used to identify or tag a video signal in a control room where a number of signals are viewed simultaneously on a number of picture monitors.

### CROSS-REFERENCE TO RELATED APPLICATIONS

The present patent application claims the priority benefit of the filing date of UK Application No. 0305678.5 filed Mar. 12, 2003 which is incorporated herein by reference.

### BACKGROUND OF THE INVENTION

This invention is directed to the display of information associated with a television picture.

In television control rooms where technical and/or production staff need to view a number of picture monitors, for example the inputs and outputs of a vision mixer, it is common practice to provide a text display underneath each picture monitor so as to identify the signal being displayed. The display is typically a label describing the picture material, the name of the signal source or some other “tag” to identify the signal. It can also be used to display the status of the signal or other pertinent information. In production control rooms camera operator's names are often displayed so that the producer can address instructions to a particular operator over a common talkback channel.

Typical under monitor displays consist of a rectangular box having the same width as the picture monitor with an LED array on the front face to display text. Often some other indicators such as red on-air lights are provided. There may be one box below each monitor, or a box with two displays may be fitted between two monitors. They are typically 1 rack unit (13/4 inches) high and 19″ wide so that they fit neatly into a standard bay-frame used to mount the monitors.

Space is usually at a premium in control rooms and there is a conflict between the need to provide displayed information and the need to fit in as many monitors as possible. Under monitor displays also need power supplies and generate heat. They also add to the cost of the installation.

### BRIEF SUMMARY OF THE INVENTION

The invention consists, in one aspect, of a method of displaying a video signal together with associated information, wherein the video is transformed from a first scanning raster to a second scanning raster having a different aspect ratio from the first, the transformation providing compensation for the aspect ratio change, and the transformed video occupies only part of the second scanning raster; characterised in that some or all of unoccupied part of the second raster is used to display the associated information.

The inventor has appreciated that a novel solution to the problem of providing space for under monitor displays is made possible by the trend towards wide-screen television production.

Historically television pictures had an aspect ratio (width to height ratio) of 4:3. Modern program production is making increasing use of the wider 16:9 ratio; and high definition television uses this ratio exclusively. Picture monitors, especially “standard definition” monitors, are made with displays of both these aspect ratios and “aspect ratio converters” which geometrically transform pictures to compensate for display on the “wrong” display shape are well-known. This conversion may be done in such a way that some picture information is not shown, or so that part of the display area is not used, or a combination of the two.

In another aspect the invention consists in a method of displaying a video signal together with associated information, wherein the video is transformed from a first scanning raster to a second scanning raster having a different aspect ratio from the first, the transformation providing compensation for the aspect ratio change, and the transformed video occupies only part of the second scanning raster; characterised in that a display device for the associated information obscures some or all of the unoccupied part of the second raster at a display device.

Suitably, the first raster has a 16:9 aspect ratio and the second raster has a 4:3 aspect ratio.

Alternatively, the first raster has a 4:3 aspect ratio and the second raster has a 16:9 aspect ratio.

Advantageously, the first raster is a high-definition raster and the second raster is a standard definition raster.

In a further aspect the invention consists of down conversion apparatus for converting a high definition video signal into a standard definition video signal characterised in that the converted picture does not occupy the whole of the output scanning raster, and all or part of the unoccupied raster is used to display information associated with the video signal.

Advantageously, the apparatus is provided with a control input for changing the displayed information.

In a further aspect the invention consists in a display device for displaying information associated with an aspect ratio converted video signal, where the converted signal does not fill the entire frame, intended to be placed in front of a video display characterised in that at least one eighth of the said video display's display area is obscured.

In a yet further aspect, the invention provides apparatus for displaying a video signal with associated information, comprising a first input for receiving a video signal, a second input for receiving a data signal, means for converting the video from a first scanning raster to a second scanning raster having an aspect ratio different from the first such that the video occupies a first part of the second raster, and means for displaying the data in a second part of the second raster unoccupied by the video.

In another aspect, the invention provides a method of monitoring a video signal, comprising receiving a video signal having a first scanning raster; converting said video signal to a second scanning raster having a different aspect ratio to the first, the transformation providing compensation for the aspect ratio change, and wherein the transformed video occupies only part of the second raster; associating a monitoring signal with said video signal; and displaying said monitoring signal on some or all of the unoccupied part of the second raster.

In yet another aspect the invention provides downconversion apparatus for converting a high definition video signal into a standard definition video signal comprising a video input for receiving a video signal; means for converting said video signal such that the converted picture does not occupy the whole of the output scanning raster; and a data input for receiving display information associated with the video signal to be displayed in all or part of the unoccupied raster.

In a further aspect the invention provides a method of operating a video control room comprising receiving a video signal; converting said video signal from a first scanning raster to a second scanning raster having a different aspect ratio to the first, the transformation providing compensation for the aspect ratio change, and wherein the transformed video occupies only part of the second raster; simultaneously displaying on a single monitor in the control room the converted video signal and information associated with said video signal on some or all of the unoccupied part of the second raster.

Preferably the associated information is provided by associating a monitoring signal with the received video signal. This monitoring signal is advantageously provided at the control room. It will often be desirable for the associated information to represent control room parameters such as a mixer channel number or an on air indicator. The associated information may also represent external parameters such as camera location, or source type. It is possible for a combination of these options to be used advantageously. In certain applications the control room will be configured for a particular purpose, such that video signals are displayed with particular information relevant for that purpose.

A still further aspect of the invention provides a method of monitoring a plurality of video signals from a corresponding plurality of different sources, the method comprising converting each said video signal to a second scanning raster having a different aspect ratio to the first, the transformation providing compensation for the aspect ratio change, and wherein the transformed video occupies only part of the second raster; deriving, for each video signal, a monitoring signal indicative of the source of that video signal; displaying said plurality of video signals on an array of monitors, including displaying on the unoccupied raster of a monitor, the monitoring signal associated with the video signal being displayed on that monitor.

The monitoring signal is preferably provided by a source distinct from the video source.

Another aspect of the invention provides a video monitoring system comprising a plurality of video inputs; means for associating a monitoring signal with an input video signal; a scan converter for converting an input video signal from a first scanning raster to a second scanning raster having a different aspect ratio to the first, the transformation providing compensation for the aspect ratio change, and wherein the transformed video occupies only part of the second raster; and an array of monitors, the system being adapted to display in the unoccupied raster of a monitor the monitoring signal associated with the video signal being displayed on that monitor.

### BRIEF DESCRIPTION OF THE DRAWINGS

Examples of the invention will now be described with reference to the drawings in which:

FIG. 1 shows a block diagram of a video processor according to an embodiment of the invention;

FIGS. 2 and 3 show the results of two different aspect ratio conversion processes;

FIGS. 4 and 5 show the appearance of two different video displays in 25 accordance with embodiments of the invention;

FIG. 6 shows an alternative embodiment of the invention; and

FIG. 7 shows a video monitoring system according to an embodiment of the invention.

### DETAILED DESCRIPTION OF THE INVENTION

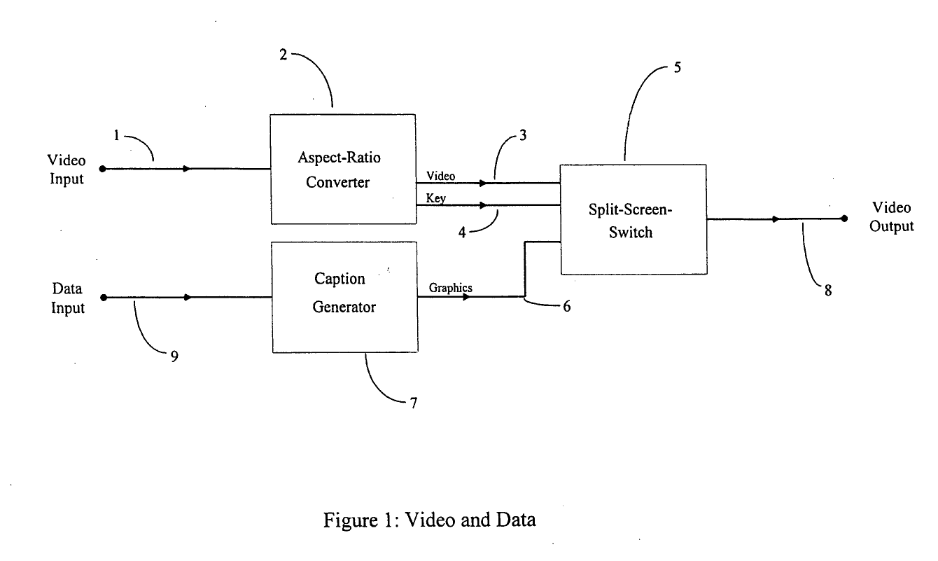

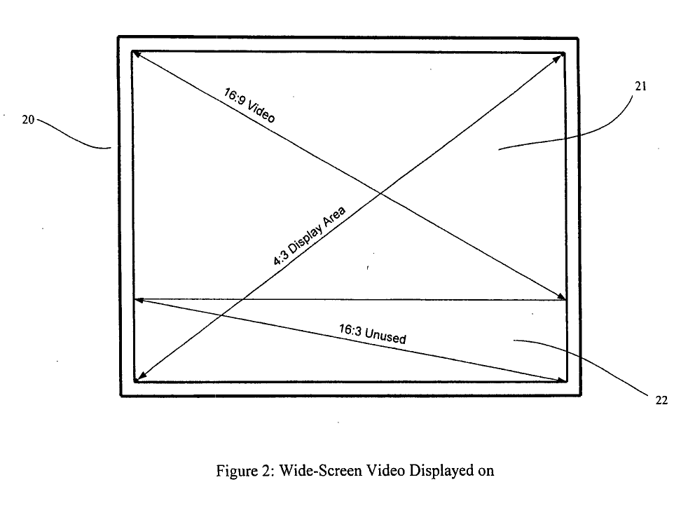

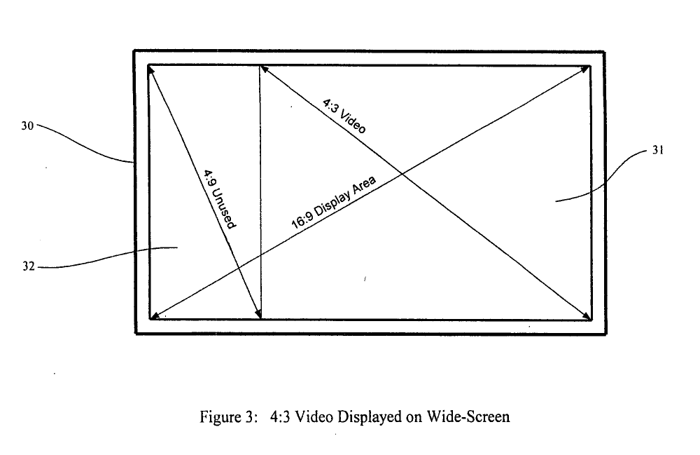

Referring to FIG. 1, a video input signal (1) is input to an aspect ratio converter (2). This converter transforms the shape of the input picture to make it suitable for display on a display device having an aspect ratio which differs from that intended for the input signal (1). The transformation is done in such a way that some part of the output frame is not used. Two examples of such transformations are shown in FIGS. 2 and 3, which show how an input is fitted into a display area without introducing geometric distortion.

FIG. 2 shows a 4:3 display (20) of a 16:9 input picture (21) where the input picture is placed at the top of the display leaving an unused space (22).

FIG. 3 shows a 16:9 display (30) of a 4:3 picture (31) where the input picture is placed at the right hand side of the display leaving an unused space (32).

Returning to FIG. 1, the aspect ratio converter (2) has two outputs: the converted video signal (3), and a key signal (4). The video signal (3) is passed to one input of a split-screen-switch (5), which is controlled by the key signal (4). A second video input (6) of the split-screen-switch (5) is fed from a caption generator (7).

The aspect ratio converter (2) controls the split screen switch via the key signal (4) so that its output video signal (8) comprises the video signal (3) during those parts of the active picture raster corresponding to the transformed video signal, and comprises the output (6) of the caption generator (7) during the remaining, unused, active picture raster.

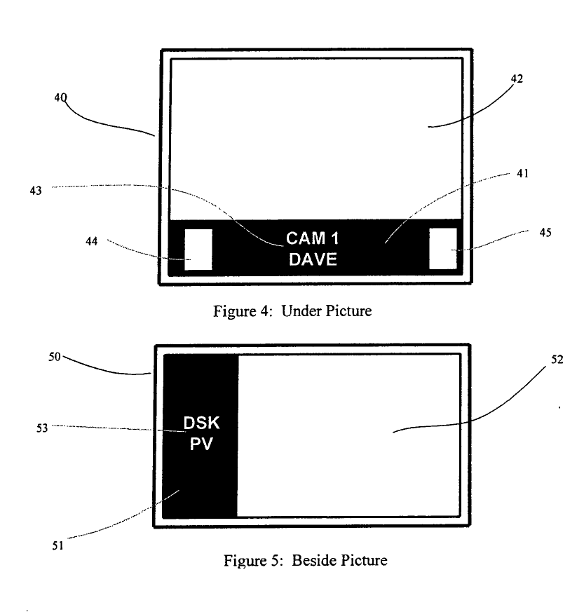

The caption generator (7) is pre-programmed in known manner so as to provide text and graphical information associated with the video signal (1), formatted so as to coincide with the unused parts of the transformed video signal (3). A data input (9) controls the displayed text and graphics in real time; for example to operate red on-air symbols when the video signal (1) is selected for transmission. Two examples of how the output video signal (8) might appear are shown in FIGS. 4 and 5.

FIG. 4 shows a 4:3 display (40) where the space (41) beneath a 16:9 picture area (42) is used to show related text (43) and “on-air” indicators (44) and (45).

FIG. 5 shows a 16:9 display (50) where the space (51) beside a 4:3 picture area (52) is used to show related text (53).

This concept can be applied in a number of ways. For example in high definition production the signal may be down-converted to standard definition for monitoring purposes, so as to enable cheaper, standard definition picture monitors to be used. It is common for down converters to include aspect ratio conversion, and the invention can therefore be embodied in such a down converter. Conversion of video to computer scan formats also can involve aspect ratio conversion and so the invention can be embodied in a “video to computer” converter, or a display upconverter.

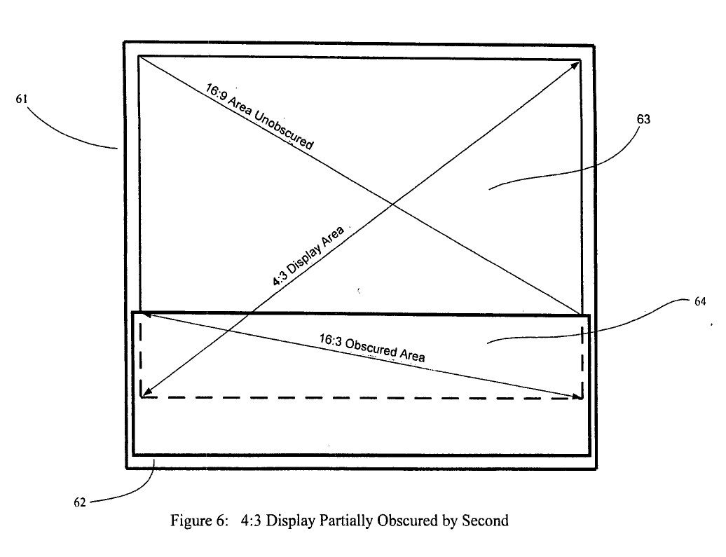

A further embodiment of the invention is shown in FIG. 6. In this case the text and graphics are not combined with the video signal but are displayed on a conventional display device, such as an array of light-emitting-diodes, which is adapted to fit in front of a picture monitor covering part of the monitor's display area.

Referring to FIG. 6, a picture monitor, or other video display device, (61) has a 4:3 display area which is partially covered by a display panel (62). The part which is not obscured (63) has an aspect ratio of 16:9. The remaining 16:3 area (64) is hidden behind the display panel (62).

The monitor is fed with a video signal which comprises a 16:9 aspect ratio picture occupying the upper part of the display screen. The display panel (63) is used to display information associated with the video signal. It can, if necessary, be larger than the unused part (64) of the video display; provided it does not obscure the display area corresponding to the 16:9 picture.

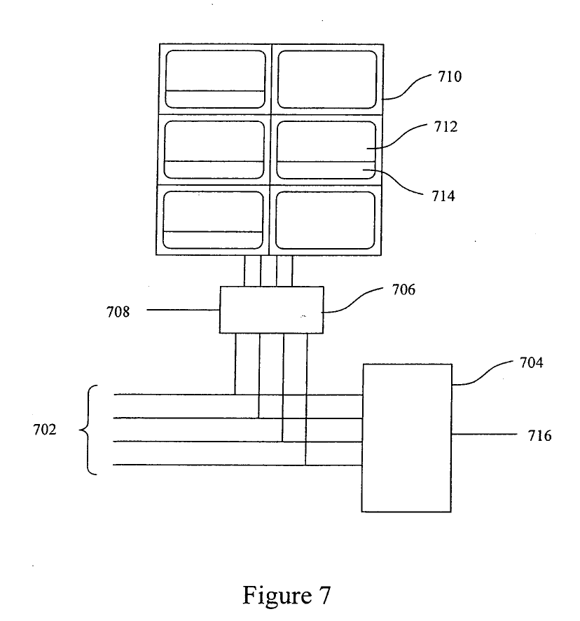

With reference to FIG. 7, there is shown a video monitoring system including a number of video inputs 702 to a video processor 704, which may be an editing or mixing desk with a user interface for example, having an output 716. Each of the video inputs is also coupled to a display pre-processor 706. The display preprocessor includes a scan converter for converting the scanning raster as explained above, and additionally includes a signal adder to combine a monitoring signal with the converted video signals. The monitoring signals are derived from input 708 of the display pre-processor. This input is controlled by a user to selectively display desired monitoring information, for example input 708 may be provided by the processor 704 in response to a user input. The preprocessor outputs the converted video signals and associated monitoring signals to a bank of monitors 710. The bank of monitors will typically be mounted in an equipment rack, the individual monitors mounted directly on top of one another. For those signals which have been scan converted, the video portion of the signal is displayed in an upper area of the display 712, and the associated monitoring signal is displayed in a lower portion of the same display 714.

It will be appreciated by those skilled in the art that the invention has been described by way of example only, and that a variety of alternative approaches may be adopted without departing from the scope of the claims.

1. A method of displaying a video signal together with associated information comprising transforming the video from a first scanning raster to a second scanning raster having a different aspect ratio from the first, the transformation providing compensation for the aspect ratio change, and the transformed video occupying only part of the second scanning raster; and using some or all of the unoccupied part of the second raster to display the associated information.

2. A method of displaying a video signal together with associated information comprising transforming the video from a first scanning raster to a second scanning raster having a different aspect ratio from the first, the transformation providing compensation for the aspect ratio change, and the transformed video occupies occupying only part of the second scanning raster; and using a display device to display the associated information, said display device obscuring some or all of the unoccupied part of the second raster.

3. A method according to claim 1 where the first raster has a 16:9 aspect ratio and the second raster has a 4:3 aspect ratio.

4. A method according to claim 1 where the first raster has a 4:3 aspect ratio and the second raster has a 16:9 aspect ratio.

5. A method according to claim 1 in which the first raster is a high-definition raster and the second raster is a standard definition raster.

6. Downconversion apparatus for converting a high definition video signal into a standard definition video signal wherein the converted picture occupies less than the whole of the output scanning raster, and said apparatus using all or part of the unoccupied raster to display information associated with the video signal.

7. Apparatus according to claim 6 comprising a control input for changing the displayed information.

8. A display device for displaying information associated with an aspect ratio converted video signal, where the converted signal occupies less than the entire frame, intended said device to be placed in front of a video display, said display device, when in place, obscuring at least one eighth of the said video display's display area.

9. Apparatus for displaying a video signal with associated information, comprising a first input for receiving a video signal, a second input for receiving a data signal, means for converting the video from a first scanning raster to a second scanning raster having an aspect ratio different from the first such that the video occupies a first part of the second raster, and means for displaying the data in a second part of the second raster unoccupied by the video.

10. A method of monitoring a video signal, said method comprising:
receiving a video signal having a first scanning raster;
converting said video signal to a second scanning raster having a different aspect ratio to the first, the transformation providing compensation for the aspect ratio change, and wherein the transformed video occupies only part of the second raster;
associating a monitoring signal with said video signal; and
displaying said monitoring signal on some or all of the unoccupied part of the second raster.

11. Downconversion apparatus for converting a high definition video signal into a standard definition video signal, said apparatus comprising:
a video input for receiving a video signal;
means for converting said video signal such that the converted picture occupies less than the whole of the output scanning raster; and
a data input for receiving display information associated with the video signal to be displayed in all or part of the unoccupied raster.

12. Apparatus according to claim 11, further comprising a control input for selecting display information to be displayed in all or part of the unoccupied raster.

13. A method of operating a video control room, the method comprising:
receiving a video signal and an associated signal carrying video control information;
converting said video signal from a first scanning raster to a second scanning raster having a different aspect ratio to the first, the transformation providing compensation for the aspect ratio change, and wherein the transformed video occupies only part of the second raster; and
simultaneously displaying on a single monitor in the control room the converted video signal and said control information on some or all of the unoccupied part of the second raster.

14. A method according to claim 13, wherein said video control information is generated at the control room.

15. A method according to claim 13, wherein said video control information represents control room parameters.

16. A method according to claim 13, wherein said video control information represents external parameters.

17. A method of monitoring a plurality of video signals from a corresponding plurality of different sources, the method comprising:
converting each said video signal to a second scanning raster having a different aspect ratio to the first, the transformation providing compensation for the aspect ratio change, and wherein the transformed video occupies only part of the second raster;
deriving, for each video signal, a monitoring signal indicative of the source of that video signal; and
displaying said plurality of video signals on an array of monitors, including displaying on the unoccupied raster of a monitor, the monitoring signal associated with the video signal being displayed on that monitor.

18. A video monitoring system comprising:
a plurality of video inputs;
means for associating a monitoring signal with an input video signal;
a scan converter for converting an input video signal from a first scanning raster to a second scanning raster having a different aspect ratio to the first, the transformation providing compensation for the aspect ratio change, and wherein the transformed video occupies only part of the second raster; and
an array of monitors;
the system being adapted to display in the unoccupied raster of a monitor the monitoring signal associated with the video signal being displayed on that monitor.
